(19) United States
(12) Patent Application Publication
(10) Pub. No.: US 2021/0062661 A1
(43) Pub. Date: Mar. 4, 2021

(54) COMPOSITE PROPULSOR BLADE RETENTION STRUCTURE AND METHOD FOR CONSTRUCTING SAME

(71) Applicant: Rotating Composite Technologies, LLC, Kensington, CT (US)

(72) Inventor: Eric Stephen Loos, Glastonbury, CT (US)

(73) Assignee: Rotating Composite Technologies, LLC, Kensington, CT (US)

(21) Appl. No.: 17/004,592

(22) Filed: Aug. 27, 2020

Related U.S. Application Data
(60) Provisional application No. 62/892,825, filed on Aug. 28, 2019.

(51) Int. Cl. F01D 5/30; F01D 5/28

(52) U.S. Cl. CPC F01D 5/3023; F01D 5/282; F05D 2300/603; F05D 2240/50; F05D 2260/31; F05D 2230/23

(57) ABSTRACT

A structure and a method of constructing a root joint and blade retention mechanism of a composite airfoil of a propulsor blade is presented. The retention assembly includes an inner sleeve configured to retain a root area of the composite propulsor blade. The inner sleeve is fixedly attached to an inner surface of the root area by a resin transfer molding process. An outer sleeve is bonded to an outer surface of the composite propulsor blade after the completion of the resin transfer molding process. At least one bearing assembly is disposed within an annular groove of the outer sleeve. The bearing assembly rotatably couples the propulsor blade and the retention assembly to a hub assembly.

### CROSS-REFERENCE TO RELATED APPLICATION

This patent application claims the benefit of U.S. Provisional Application No. 62/892,825, filed Aug. 28, 2019, the content of which is incorporated herein by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This invention relates to composite structures, and more particularly to improvements in a structure and a method of constructing a blade retention mechanism and root area of a composite airfoil of a propulsor blade used in aircraft propulsion systems such as, for example, propellers, ducted fans, and the like.

### BACKGROUND

The design disclosed herein provides improvements over a prior invention disclosed in U.S. Pat. No. 6,676,080 B2, issued Jan. 13, 2004, titled “Composite Airfoil Assembly,” by John A. Violette (hereinafter the “'080 patent”), which is incorporated by reference herein in its entirety. The prior, patented invention achieved a significant reduction in the weight of the root attachment joint of composite propulsor blades, while maintaining a high level of strength, safety and durability, which are highly desirable characteristics in aircraft applications. An improvement of the design of the '080 patent is disclosed in U.S. Patent Application Publication No. 2018/0290728 A1, published Oct. 11, 2018, titled “Composite Propulsor Blade Support Structure and System,” by John A. Violette and Eric Stephen Loos, which is also incorporated by reference herein in its entirety. This improvement discloses, inter alia, a preloading component configured to apply a residual compressive force to at least one sleeve and the root portion of the propulsor blade; the residual compressive force being configured to maintain an attachment of the at least one sleeve to the root portion.

As is known, the root portions of propulsor blades typically terminate in a cylindrical shape to accommodate cooperation with a variety of low friction bearing assemblies, generally consisting of ball and/or roller elements. These bearing assemblies interface with individual blade sockets or “arms” of a central hub assembly. In such installations, the bearing assemblies allow the blades to be rotatable, and a pitch control system allows the pitch angle of all blades to be varied simultaneously to maximize thrust for different aircraft operating conditions, resulting in greater aircraft propulsive efficiency.

In addition to the cylindrical shape of the root portion, one or more rings, sleeves or similar components are integrally bonded to inner and outer portions of the cylindrical shaped root portion to accommodate installation of the low friction bearing assemblies. The rings, sleeves or similar components are typically constructed of aluminum, steel or other metals having suitable strength and wear characteristics. For example, and as described in the '080 patent, during construction of a propulsor blade assembly, layers of composite material (e.g., braided glass fiber and graphite) are first dry assembled together with the rings, sleeves or similar components and then inserted into a mold. A suitable resin is then injected into the mold to fill voids and spaces between the composite layers and the rings, sleeves or similar components. The resin is cured at elevated temperature. This process is known to persons skilled in the art as a resin transfer molding (RTM) process. While generally effective for bonding purposes, the composite and metal materials react differently at elevated temperature and thus thermal stresses may be introduced in the composite blade to metal ring/sleeve bond. The inventor has recognized that this thermal stress can introduce misalignment and other undesirable conditions into the method for forming a propulsor blade assembly.

Accordingly, the inventor has discovered that one solution would be to remove at least some of the bonding process currently being done before or in the RTM process, for example, to perform the composite blade to outer sleeve bonding after the RTM process to reduce thermal stresses. In still another improvement, the inventor has discovered that use of a single-row bearing assembly and, for example, a thrust bearing, to retain the blade and reduce ball contact stresses allowing the bearing to carry a greater load without increasing its size. Also, the single-row bearing assembly allows for the removal of other bearings thus reducing an amount of weight and corresponding load on the remaining, single-row bearing assembly.

### SUMMARY

An embodiment of a blade retention assembly for a blade having a root area at one end of the blade, which includes an inner cavity with a root opening at the one end defined by annular ridge extending radially inward. The blade retention assembly includes an outer sleeve disposed circumferentially around an outer surface of the root area of the blade. The outer sleeve includes a support extending radially inward configured to engage an outer portion of the annular ridge of the root portion of the blade. The support defines a through-bore therein. An inner sleeve includes an inner portion disposed circumferentially around an inner surface of the root area of the blade within the inner cavity and a lower portion disposed circumferentially around an inner portion of the annular ridge of the root area of the blade. A fastener is configured to attach and draw the inner sleeve and outer sleeve together to clamp the annular ridge of the root area of the blade therebetween.

An embodiment of a blade assembly includes a blade having a root area at one end of the blade. The root area includes an inner cavity with a root opening at one end defined by an annular ridge extending radially inward. A blade retention assembly includes an outer sleeve disposed circumferentially around an outer surface of the root area of the blade and includes a support radially extending inward configured to engage an outer portion of the annular ridge of the root area. The support defines a through-bore therein. An inner sleeve includes an upper portion disposed circumferentially around an inner surface of the root area of the blade within the inner cavity and a lower portion disposed circumferentially around an inner portion of the annular ridge of the root area of the blade. A fastener configured to attach and draw the inner sleeve and outer sleeve together to clamp the annular ridge of the root area of the blade therebetween.

An embodiment of a method of attaching a blade to a blade retention assembly includes attaching an inner sleeve of the blade retention assembly within a cavity of a root area of the blade by a resin transfer molding process. The method further includes attaching an outer sleeve of the blade retention assembly to an outer surface of root area of the blade after completion of the resin transfer molding process.

### BRIEF DESCRIPTION OF THE DRAWINGS

FIG. 1 is a side view of an embodiment of a complete composite propulsor blade assembly with a support bearing, allowing rotation about the blade longitudinal axis, a pitch change pin and root area feature incorporated in accordance with the present invention.

FIG. 2 is a perspective view of an example of a propulsor system configured as a propeller assembly having six blades supported by a central metallic hub.

FIG. 3 is a close-up perspective view of the central region of the propulsor system of FIG. 2.

FIG. 4 is a cross-sectional view of a root portion of a first embodiment of a root portion of a composite propulsor blade assembly and aspects of an embodiment of a blade retention assembly in accordance with the present invention.

FIG. 5 is a perspective view in partial cross-section of the first embodiment of the root portion of the composite propulsor blade assembly of FIG. 4.

FIG. 6 is a flow diagram of the method of constructing a blade and a blade retention assembly in accordance with the present invention.

FIG. 7 is a cross-sectional view of a root portion of a second embodiment of a composite propulsor blade assembly and aspects of an embodiment of a blade retention assembly in accordance with the present invention.

FIG. 8 is a perspective view in partial cross-section of the first embodiment of the root portion of the composite propulsor blade assembly of FIG. 7.

FIG. 9 is a cross-sectional view of a lower portion of a third embodiment of a composite propulsor blade assembly and aspects of an embodiment of a blade retention assembly in accordance with the present invention.

FIG. 10 is a perspective view in partial cross-section of the third embodiment of the root portion of the composite propulsor blade assembly of FIG. 9.

FIG. 11 is a cross-sectional view of a root portion of a fourth embodiment of a composite propulsor blade assembly and aspects of an embodiment of a blade retention assembly in accordance with the present invention.

### DETAILED DESCRIPTION

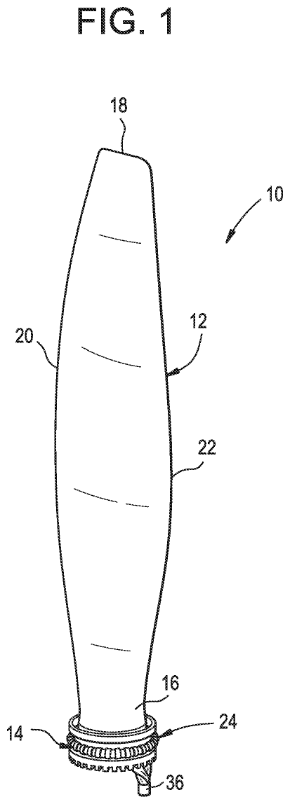

FIGS. 1 to 11 illustrate a method of constructing and embodiments of a composite blade assembly and a blade retention assembly configured to apply a compressive force to a root area or a base portion of a propulsor blade to compensate for variations in loading on the blade that can cause bending fatigue, reduced efficiency and/or failure. A resin transfer molding (“RTM”) process is used to form the blade with and bonded to specific components of the blade retention assembly to improve the layering of sheet material of the blade and reduce thermal stress during the molding process. The blade assembly configured in accordance with embodiments described herein allows reductions in the diameter and weight of the root portion of a composite blade. Specifically, the blade is also formed to include an inwardly extending annular ridge for securing the blade to the blade retention assembly, which reduces the outer diameter of the blade retention assembly. As can be appreciated, decreasing the diameter of the blade root provides additional weight reduction and aerodynamic performance benefits to the entire aircraft propulsion system of current and “next generation” aircraft, where the trend is to, for example, increase the number of blades to reduce propulsor external noise and vibration transmitted to passengers. Further, one embodiment of the blade retention assembly provides a single bearing assembly to reduce the weight of the blade assembly while permitting the blade to rotate within the hub assembly. In these embodiments, the propulsor blade is described as a propeller, but is not so limited, and can be any type of blade that is subject to rotations, such as a composite airfoil of a propulsor blade used in aircraft propulsion systems such as, for example, propellers, ducted fans, and the like.

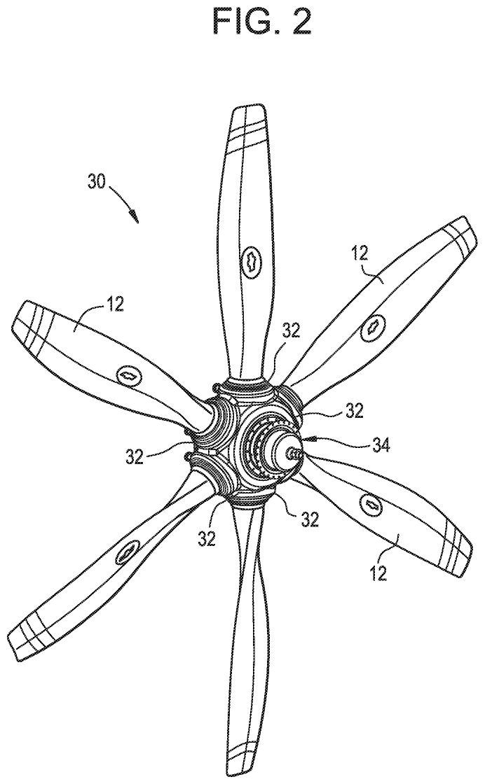

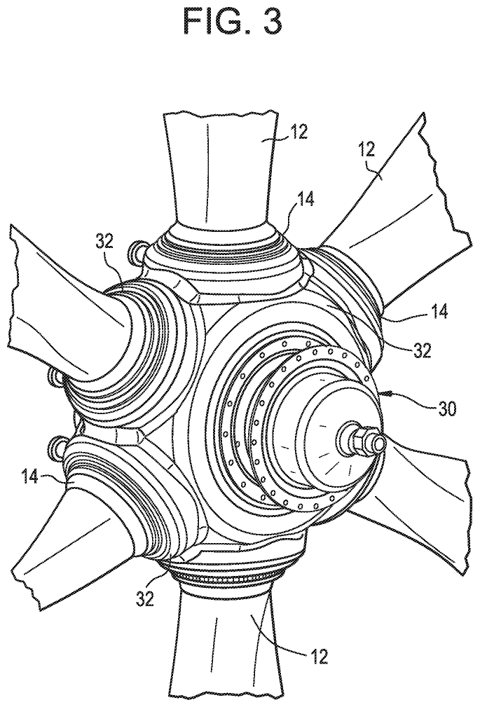

FIGS. 1 to 3 show an embodiment of a composite blade assembly 10 that includes a composite propulsor blade 12 in operable connection with a blade retention assembly 14. The blade 12 may be constructed of a composite material and adapted for connection to an arm 32 of a hub 34 of a propulsion system 30, such as that shown in FIGS. 2 and 3. The propulsion system may be one of a variety of aircraft propulsion systems, such as a propeller, a ducted fan, a helicopter rotor, a disk structure of a jet engine compressor fan assembly, or the like.

The blade 12 includes a root area 16 (i.e., a base portion), a tip 18, and a leading edge 20 and a trailing edge 22 that extend between the root area 16 and the tip 18. The blade 12, in one embodiment, is cylindrical in shape at the root area 16 and transitions to an airfoil that thins, twists and flattens toward the tip 18 in a well-known manner, depending on the type of propulsor blade to be constructed. A root portion 24 of the blade assembly 10 includes the blade retention assembly 14 configured to receive and securely mount the root area 16 of the blade 12 to the hub 34, such as that shown in FIG. 2.

FIGS. 2 and 3 show an example of the propulsor system 30 in which embodiments described herein can be incorporated. In this example, the propulsor system 30 includes six blades 12 supported by a respective hub arm 32 of a central metallic hub 34. The hub 34 has an internal mechanism (not shown) that allows the pitch of all six blades to be adjusted and controlled for each aircraft flight condition. In one embodiment, the internal mechanism is configured to engage a pitch change pin or other structure (e.g., pin 36 as show in FIG. 1 and described further below) connected to the root portion 24 of each blade assembly 10. Note that in this example, an outer shell structure (not shown), typically called a spinner nose cone, which forms a smooth aerodynamic shape over the hub 34 and root portion 24 of each blade assembly 10, is mounted on the hub.

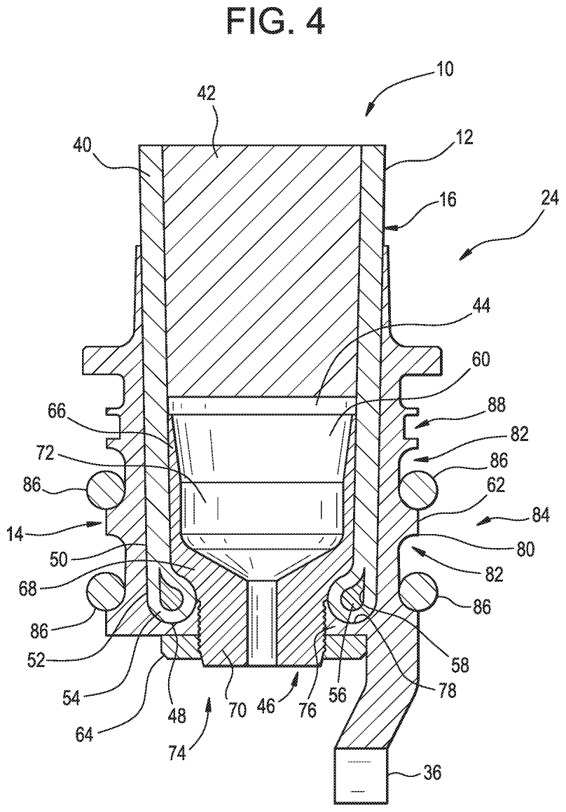

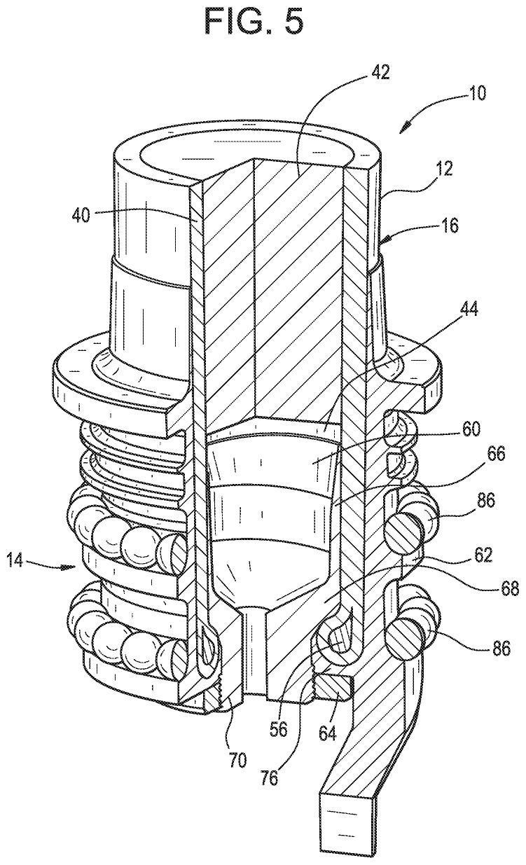

With reference to FIGS. 4 and 5 illustrating an enlarged, cross-sectional view of the root portion 24 of the blade assembly 10, in one embodiment, an outer portion 40 of the blade 12 may be constructed of layers of braided high-strength composite fibers such as glass, Kevlar™, carbon or the like, and layers of similar high-strength fibers that are uni-directional (in a form that are either woven or otherwise bound for ease of handling), positioned between the braided layers and oriented primarily along the blade axis. The braided and uni-directional composite layers are preferably continuous and are embedded in a suitable resin material. Those knowledgeable in the art of designing and analyzing high-strength composite structures can select and combine various composite fibrous materials and resin candidates that are compatible in order to optimize the blade's tensile and torsional stiffness properties, as well as the strength, toughness, durability and other required characteristics of the blade 12, including acceptable, tuned, resonant frequencies and deflections.

The outer portion 40 of the blade 12 is formed adjacent to an inner foam core 42 located in an interior of the blade portion 12. The foam core 42 may be constructed of a lightweight, closed-cell foam material, such as polyurethane foam. As shown, the foam core 40 may stop short of the lower end of the root area 16 to form an internal cavity 44 having an opening 46 at the lower end of the root area. The opening 46 is defined by an annular ridge 48 extending radially inward into the internal cavity 44 of the root area 16. The annular ridge 48 is configured to facilitate connection of the root area 16 of the blade 12 to the blade retention assembly 14, which will be described in greater detail hereinafter. An outer surface 50 of the root area 16, including the annular ridge 48 extending inwardly, provides a generally uniform cylindrical outer wall 52, and thus, provides a root area 16 with a smaller outer diameter than disclosed in prior art embodiments that provide an annular ridge extending radially outward from the outer surface of the root area of the blade as shown in U.S. Pat. No. 6,676,080 B2. The reduced outer diameter of the root area 16 of the blade assembly 14 results in reductions in the diameter and weight of the root portion 24 of the composite blade assembly 10. As can be appreciated, decreasing the outer diameter of the blade root area 16 provides additional weight reduction and aerodynamic performance benefits to the entire aircraft propulsion system of current and “next generation” aircraft, where the trend is to, for example, increase the number of blades to reduce propulsor external noise and vibration transmitted to passengers.

As shown in FIGS. 4 and 5, the annular ridge 48 may be a toroidal composite loop 54 extending radially inward. The toroidal loop 54 may be formed by wrapping the layers of the outer portion 40 of the blade 12 around an internal ring 56 to join the internal ring and layers at their mutual conforming surfaces 58. In one embodiment, the internal ring 56 may be a monolithic or one-piece ring having a cross-sectional geometric or free form shape (e.g., a round, teardrop or triangular shape) that defines the shape of an internal annular cavity formed by the composite loop 54.

In one embodiment, as shown in FIGS. 4 and 5, the blade retention assembly 14 may include an inner sleeve 60 and an outer sleeve 62 secured together by a high capacity nut 64 to draw the inner sleeve 60 and the outer sleeve 62 together to clamp the toroidal loop 54 of the blade 12 between the inner sleeve 60 and the outer sleeve 62. The nut 64 transfers part of the composite blade steady and vibratory loads to the outer sleeve. Further, both joints of the inner sleeve 60 and the outer sleeve 62 share the support of the blade loads, thus reducing shear stresses in both.

The inner sleeve 60 is disposed within the inner cavity 44 of the root area 16 of the blade 12. The outer surface of the inner sleeve 60 at least partially conforms to an inner surface of the root area 16 of the blade 12 and/or the toroidal loop 54. For example, as oriented in FIG. 4, the inner sleeve 60 includes a generally cylindrical upper portion 66 having an outer surface that conforms to the inner surface of the root area 16 of the blade 12. An intermediate portion 68 of the inner sleeve 60 tapers inwardly having a curved outer surface conforming to a portion of the upper surface of the toroidal loop 54. A lower portion 70 of the inner sleeve 60 extends downwardly through the opening 46 of the root area 16 of the blade 12. A portion of the outer surface of the lower portion 70 of the inner sleeve 60 is threaded. The inner sleeve 60 also includes an inner funnel shaped bore 72 extending longitudinally through the inner sleeve to reduce, inter alia, the weight of the blade retention assembly 14. Both the at least upper portion 66 and at least a portion of the intermediate portion 68 of the inner sleeve 60 can be bonded to the root portion 16 and the toroidal loop 54 by the RTM process, which will be described in further detail hereinafter.

The outer sleeve 62 extends circumferentially around the outer wall of the root area 16 and the toroidal loop 54 of the blade 12. The outer sleeve 62 at least partially conforms to the outer surface of the root area 16. A lower portion of the outer sleeve 62 includes an annular support 76 extending inwardly having an upper curved surface 78 that may conform to the lower portion of the toroidal loop 54 of the root area 16 of the blade 12 and the inner sleeve 60 (intermediate portion 68 and lower portion 70 of the inner sleeve 60.) A through-bore 74 in the lower portion of the outer sleeve 62 is configured to receive the threaded lower portion 70 of the inner sleeve 60 extending through the outer sleeve 62.

The threaded nut 64 is configured to secure onto the lower portion 70 of the inner sleeve 60 extending through the through-bore 74 of the outer sleeve 62 and apply a residual compressive force to the outer sleeve and the root area 16 of the blade 12. The nut 64 threads onto the lower portion 70 of the inner sleeve 60 to force the inner sleeve 62 and outer sleeve 62 together to clamp the toroidal loop 54 therebetween when tightened. The compressive force applied by the nut 64 is supplemental to the compression force provided by centrifugal loads when the blade 12 is rotating with the hub 34. The residual compressive force increases the bending capacity of the blade root 16 when the centrifugal load alone (which is typically low with lightweight composite blades) is insufficient to maintain compressive force all around the bond joint between the outer sleeve 62 and the root portion 16 when bending loads are applied.

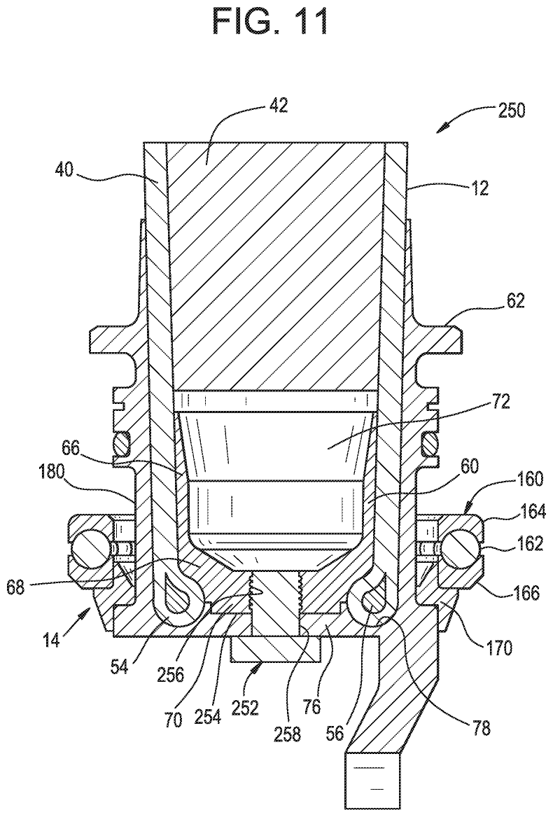

The centrifugal pull force produces a compressive load on a substantial portion of the composite between the inner sleeve 60 and outer sleeve 62. This construction is advantageous for at least the following reasons: 1) most of the composite to metal bond joint is in a state of high compression, which maximizes its shear strength by avoiding the weaker peel mode of failure; 2) the required bond area is minimized; and 3) with all composite layers wrapped around the internal ring 56, and with the internal ring 56 being too large to slip past the inner sleeve 60 under the outward centrifugal force, the blade 12 is mechanically locked to the root portion 24. Thus, should there be a bond joint failure, this construction prevents separation of the blade 12 from the root portion 24. Further, if the outer sleeve bond joint were to fail, the threaded nut joint is designed to carry all composite blade loads. Root bending capacity of the composite blade 10 is increased because the composite wrap is all enclosed in metal. The blade retention assembly 14 provides multiple load paths for redundancy, even if the outer sleeve is completely disbanded, the blade is still retained by the inner sleeve 60 and the nut 64. While the nut 64 is described as a means for securing the inner sleeve 60 and blade 20 to the outer sleeve 62, the present invention contemplates any other fastener, e.g. retaining rings and pins, may be used. Furthermore, a bolt may be used as described hereinafter in reference to FIG. 11.

The outer sleeve 62 may include various features to facilitate operable connection to the hub 34. The outer sleeve 62 has an annular surface 80 that bears against a retaining surface (not shown) of a rotor hub (not shown) in a well-known manner to prevent separation of the propulsor blade assembly 10 from the rotor hub under high outward centrifugal force during rotation of the hub.

As is known, the root portion 24 of propulsor blades 10 typically terminate in a cylindrical shape to accommodate cooperation with a variety of low friction bearing assemblies, generally consisting of ball and/or roller elements. These bearing assemblies 84 interface with individual blade sockets or arms 32 of a central hub assembly 34. In such installations, the bearing assemblies 84 allow the blades 12 to be rotatable, and a pitch control system allows the pitch angle of all blades to be varied simultaneously to maximize thrust for different aircraft operating conditions, resulting in greater aircraft propulsive efficiency.

For example, as shown in FIGS. 4 and 5, the outer sleeve 62 may include a pair of circumferential grooves or depressions 82 to accommodate a double row bearing assembly 84, including two rows of bearing elements 86, and a circumferential groove 88 to accommodate a seal (not shown), which will be described in greater detail hereinafter.

The blade assembly 10 may also include features to allow the blade pitch to be changed. For example, the blade assembly 10 includes a pitch change pin 36 extending inwardly from the base of the blade 12 and located eccentric to the blade longitudinal axis. The pin 36 interfaces with a blade pitch change mechanism (not shown) for the purpose of adjusting blade angle as desired to improve or optimize propulsor thrust according to aircraft operating condition.

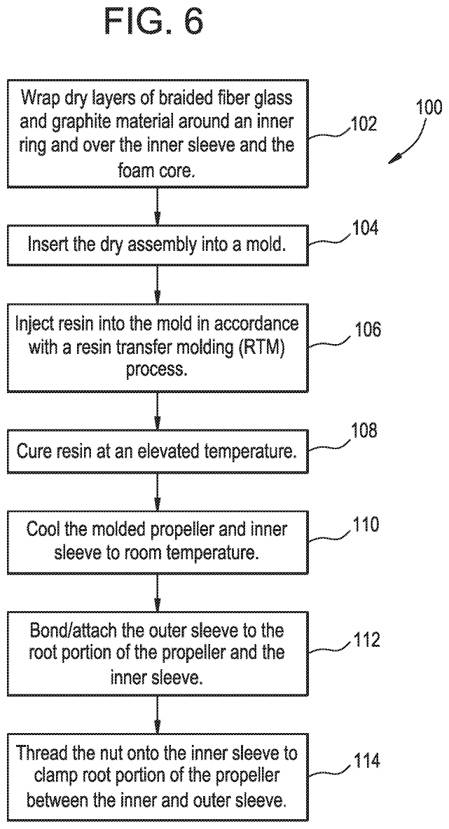

FIG. 6 shows a method 100 to construct the blade assembly 10 using the RTM process described hereinbefore. The method at 102 includes wrapping dry layers of the braided glass fiber and graphite, which forms the outer layer 40 of the blade 12 of FIGS. 4 and 5 for example, around the internal ring 56 and over the outer surface of the inner sleeve 60 and the foam core 42. The foam core 42 serves as an internal mandrel during lay-up of the dry composite layers. The closed cell construction of the foam core 42 prevents resin intrusion during the RTM process of forming the blade. While the foam core 42 is shown in FIGS. 4 and 5 stopping short of the inner sleeve 60, alternatively the foam core may extend into the inner bore 72 of the inner sleeve 60.

The dry assembly, including the inner core 42, the dry layers of material, the internal ring 56 and the inner sleeve 60, are then inserted into a mold at 104. Suitable resin at 106 is subsequently injected into the mold to fill the spaces between the inner sleeve 60, the foam core 42 and the layers of the materials to form the outer composite layer 40 of the blade 16. At 108 the resin is then cured at an elevated temperature of approximately 120° C. to 180° C., after which the assembly is released from the mold and allowed to cool to room temperature at 110. At 112 once the blade 12 with the inner sleeve 60 bonded thereto are removed from the mold and cooled to room temperature, the outer sleeve 62 also at room temperature may be bonded by an adhesive to the outer surface/wall 52 of the root area 16 of the blade 12 and the lower portion of the toroidal loop 54. Unlike the prior art, the outer sleeve 62 is not bonded to the root area 16 of the blade 12 during the RTM process in order to reduce thermal stresses between the root area 16 of the blade 12 and the outer sleeve 62 during the curing process. At 114 the nut 64 is threaded onto the threaded lower portion 70 of the inner sleeve 60 extending through the opening 46 of the outer sleeve 62. Tightening of the nut 64 draws the inner sleeve 60 and the outer sleeve 62 together thus clamping the toroidal loop 54 of the root area 16 of the blade 12 therebetween. Alternatively, the outer sleeve 62 may be bonded or attached to the root area 16 of the blade 12 simply with the nut 64 without an adhesive.

The advantages of this structure and method of constructing include, but are not limited to, minimizing thermal stresses by integrally bonding the inner sleeve 60 and the internal ring 56 to composite material of the blade 12 when the blade 12 is in the RTM process, and then subsequently bonding or attaching the outer sleeve 62 to the composite material of the blade 12 at room temperature after the blade 12 is molded. Further, the bonding or attachment of the outer sleeve 62 to the root area 16 of the blade 12 after the RTM process not only reduces joint thermal stresses, but also achieves consistent alignment between the airfoil and the blade retention, as some stacking error can be taken up in the bond line between the blade 12 and the outer sleeve 62. Also, the elimination of the outer sleeve 62 from the layup and RTM process when forming the blade 12 makes the holding of the blade easier and simpler without the outer sleeve in place because, for example, wrapping the composite layers around the internal ring 56 without the outer sleeve preserves the composite fiber alignment. As mentioned, the bonding of the outer sleeve 62 after the construction of the blade 12 assures good alignment (stacking) of bearing races to the blade outer airfoil. The assembly or bonding of the outer sleeve 62 to the blade 12 permits the outer sleeve 62 to be designed to be removable and/or replaceable for improved servicing of the blade retention, for example due to wear.

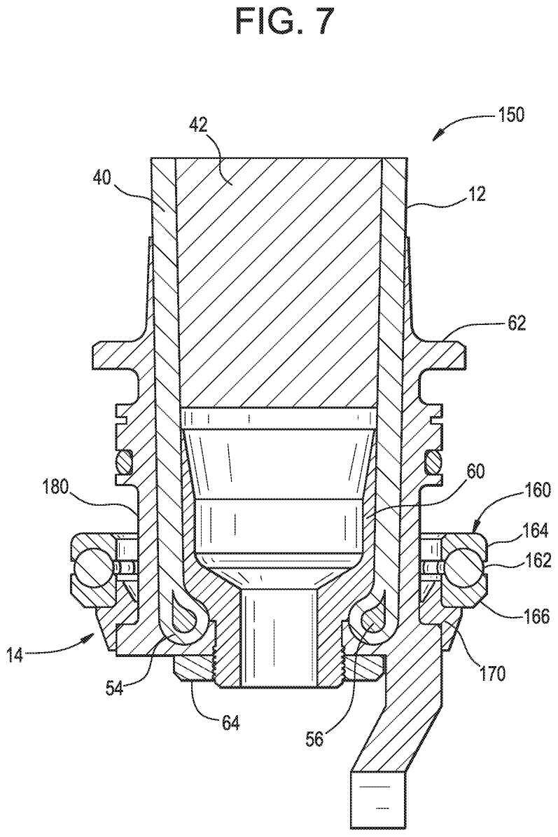

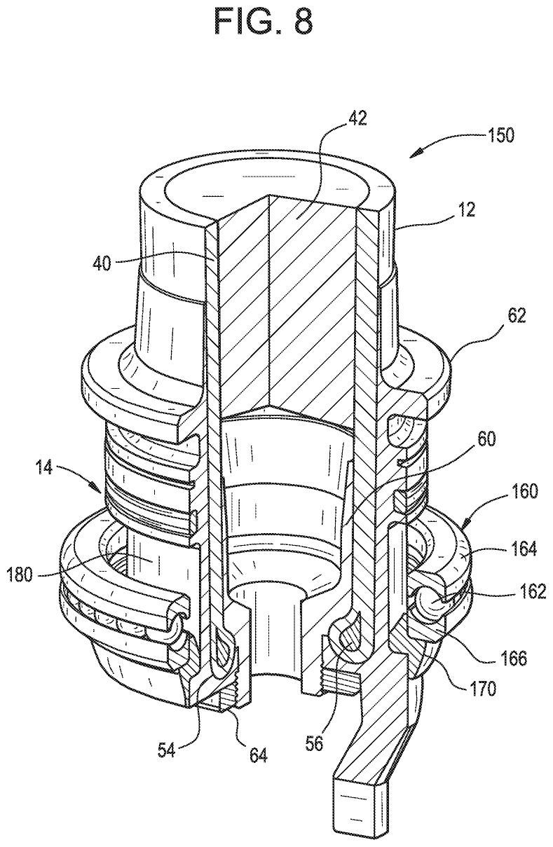

FIGS. 7 and 8 illustrate a second embodiment of a blade assembly 150, which includes similar components and features of the first embodiment of the blade assembly shown in FIGS. 4 and 5. All common components between embodiments having the same features and functions have the same reference numerals. In contrast to the first embodiment, the blade assembly 150 of FIGS. 7 and 8 include a bearing assembly 160 having a single row of bearing elements 162. The single row bearing assembly 160 may be a thrust bearing. The thrust bearing 160 includes a plurality of bearing elements 162 disposed between an upper annular race 164 and a lower annular race 166 to rotatably retain the blade assembly 150 within the hub 34. The lower race 166 of the bearing assembly 160 is supported by an annular split keeper 170 within an annular groove 180 in the outer sleeve 62. The thrust bearing 160 can reduce bearing element contact stresses allowing the thrust bearing 160 to carry a greater load without increasing its size. Advantageously, the single row bearing assembly 150 of FIGS. 7 and 8 enables a reduction of weight of the blade retention assembly 14, and thus the corresponding load on the blade assembly is reduced,

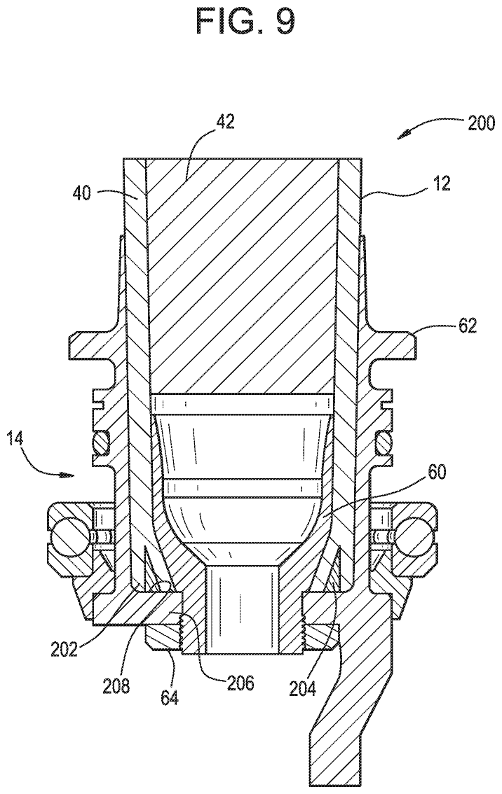

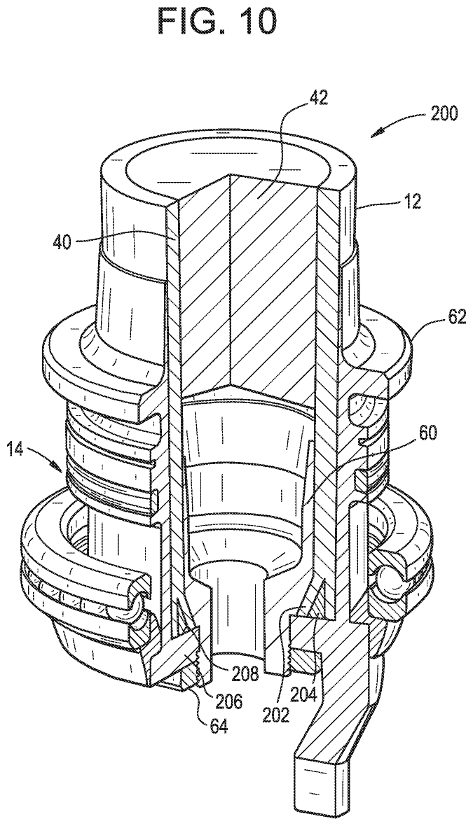

FIGS. 9 and 10 show another example of a blade assembly 200, in which the blade assembly is similar to the blade assembly 10 of FIGS. 4 and 5, and therefore similar components will have the same reference number. In contrast to the root area 16 of the blade 12 of the blade assembly 10 of FIGS. 4 and 5, an annular ridge 202 is formed using a triangular or wedge-shaped ring 204. The layers of the outer portion 40 of the blade 12 are wrapped around the triangular ring 204 with a portion or side of the ring 204 uncovered, such the uncovered side of the ring 204 engages an annular support 206 having a flat surface 208. The annular ridge 202 thus forms a dovetail resulting in flat angular surfaces that provides a flat engagement surface with the inner sleeve 60 and outer sleeve 62 to simplify manufacturing of the sleeves, and provides a more uniform surface engagement between the sleeves with the root area 16 of the blade 12.

FIG. 11 illustrates another embodiment of a blade assembly 250, which includes similar components and features of the second embodiment of the blade assembly shown in FIGS. 7 and 8. All common components between embodiments having the same features and functions have the same reference numerals. In contrast to the second embodiment, the inner sleeve 60 and the outer sleeve 62 of blade assembly 250 of FIG. 11 are secured together by at least a bolt 252 to draw the inner sleeve 60 and the outer sleeve 62 together to clamp the toroidal loop 54 of the blade 12 between the inner sleeve 60 and the outer sleeve 62. The bolt 252 transfers part of the composite blade steady and vibratory loads to the outer sleeve 62.

The outer sleeve 62 extends circumferentially around the outer wall of the root area 16, the toroidal loop 54 of the blade 12 and the lower portion 70 of the inner sleeve 60. The outer sleeve 62 at least partially conforms to the outer surface of the root area 16 of the blade 12 and the lower portion 70 of the inner sleeve 60. The lower portion of the outer sleeve 62 includes an annular support 76 extending inwardly having an upper curved surface 78 that may conform to the lower portion of the toroidal loop 54 of the root area 16 of the blade 12 and the bottom portion of the inner sleeve 60 (e.g., at least one of the intermediate portion 68 and the lower portion 70 of the inner sleeve 60.) The annular support 76 extends along at least a portion of a bottom surface 254 of the lower portion 70 of the inner sleeve 60. A lower portion of the funnel-shaped through-bore 72 provides a threaded inner surface 256 for receiving the bolt 252. The support 76 of the outer sleeve 62 includes a through-bore 258 aligned with the lower portion 30 of the funnel-shaped through-bore 72 to enable the bolt 252 to pass through the support 76 of the outer sleeve 62 and thread into the bottom portion of the inner sleeve 60. While a single bolt 252 is shown attaching the inner and outer sleeves 60, 62 together, one will appreciate a plurality of bolts may be used in a similar manner.

Embodiments described herein present a number of improvements and advantages relative to prior art configurations. The blade retention assembly and method for constructing the blade assembly described herein are seen to greatly increase the strength of composite blade designs, and greatly increase the ability to resist high levels of steady and cyclic bending loads experienced by high-power propulsion systems. In addition, the described blade retention assembly and the method for constructing the blade assembly allow for the use of compact and lightweight attachment mechanisms in propulsion systems. Such attachment mechanism interface reliably well in, e.g., central hub assemblies having a bearing and retention system for each blade, which allows for changing blade pitch angles to accommodate changing flight conditions encountered in typical flight profiles of various aircraft.

Embodiments described herein make additional reductions possible in the diameter and weight of the root portion 24 of a composite blade 12, while simultaneously increasing bending capacity. Decreasing the diameter of the blade root 24 provides additional weight reduction and aerodynamic performance benefits to the entire aircraft propulsion system of current and “next generation” aircraft, where the trend is to increase the number of blades to reduce propulsor external noise and vibration transmitted to passengers.

Manufacturers of new aircraft propellers look to increase blade count in new propellers for many reasons. The root diameter of composite blades 12 is typically quite large and heavy to accommodate high-cycle vibratory bending loads. Packaging the large retention bearings of this many blades in a central hub requires a large hub, large pitch change system, and large center body (known as a spinner assembly) to maintain smooth airflow around the root portions of the blades. One benefit of the embodiments described herein is to allow a reduction in the size of each blade root diameter, retention assembly 10 and blade support bearing assemblies, which in turn results in a smaller, more compact hub, pitch change system and spinner size, accompanied by an appreciable reduction in propeller weight, while simultaneously improving propeller efficiency. Furthermore, the reduction in blade root diameter is also seen to decrease blade inboard airfoil thickness, which helps prevent drag arising from choked air flow between blade roots, thus also improves propeller aerodynamic performance.

Although embodiments are described herein in conjunction with aircraft, they are not so limited and can be used in any suitable device or system that utilizes rotor blades. For example, rotor blades can be used in green energy capturing devices such as wind turbines and water turbines.

The terms “first,” “second,” and the like, herein do not denote any order, quantity, or importance, but rather are used to distinguish one element from another. In addition, the terms “a” and “an” herein do not denote a limitation of quantity, but rather denote the presence of at least one of the referenced item.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the foregoing description.

What is claimed is:

1. A blade retention assembly for a blade having a root area at one end of the blade, the root area having an inner cavity with a root opening at the one end defined by annular ridge extending radially inward, the blade retention assembly comprising:
an outer sleeve disposed circumferentially around an outer surface of the root area of the blade, the outer sleeve including a support extending radially inward configured to engage an outer portion of the annular ridge of the root portion of the blade, the support defining a through-bore therein;
an inner sleeve including an upper portion disposed circumferentially around an inner surface of the root area of the blade within the inner cavity and a lower portion disposed circumferentially around an inner portion of the annular ridge of the root area of the blade; and
a fastener configured to attach and draw the inner sleeve and outer sleeve together to clamp the annular ridge of the root area of the blade therebetween.

2. The retention assembly of claim 1, wherein the lower portion of the inner sleeve is configured to extend through the root opening and the through-bore of the outer sleeve; and
wherein the fastener includes a nut configured to thread onto the lower portion of the inner sleeve extending through the root opening and the through-bore of the outer sleeve.

3. The retention assembly of claim 1, wherein the lower portion of the inner sleeve includes a threaded bore; and
wherein the fastener includes a bolt configured to pass into the through-bore of outer sleeve and thread into the threaded bore of the inner sleeve.

4. The retention assembly of claim 1, wherein the fastener is a threaded fastener.

5. The retention assembly of claim 1, wherein the inner sleeve is bonded to the inner surface of the root area by a resin transfer process.

6. The retention assembly of claim 5, wherein the outer sleeve is bonded by an adhesive to the outer surface of the root area of the blade.

7. The retention assembly of claim 6, wherein the outer sleeve supports a single row bearing assembly.

8. The retention assembly of claim 1, wherein the outer sleeve having an outer surface with a first annular groove; and the blade retention assembly further comprises a first bearing disposed within the first annular groove.

9. The retention assembly of claim 1, wherein the outer sleeve has an inner surface having a uniform, cylindrical surface complementary to the outer surface of the root area of the blade.

10. The retention assembly of claim 1, wherein the annular ridge of the root area of the blade forms a toroidal loop extending inwards from the outer surface of the root area.

11. The retention assembly of claim 10, further comprising a ring disposed within an opening of the toroidal loop.

12. The retention assembly of claim 1, wherein the annular ridge of the root area forms a dovetail extending inwards from the outer surface of the root area of the blade.

13. The retention assembly of claim 12, further comprising an annular wedge disposed within an opening of the dovetail of the root area of the blade.

14. The retention assembly of claim 1, further comprising a plurality of ball bearings disposed between a pair of races formed on an outer surface of the outer sleeve.

15. The retention assembly of claim 1, further including a keeper having an annular groove to support a bearing on an outer surface of the outer sleeve.

16. A blade assembly comprising:
a blade having a root area at one end of the blade, the root area having an inner cavity with a root opening at one end defined by an annular ridge extending radially inward; and
a blade retention assembly comprising:
an outer sleeve disposed circumferentially around an outer surface of the root area of the blade, the outer sleeve including a support radially extending inward configured to engage an outer portion of the annular ridge of the root area of the blade, the support defining a through-bore therein;
an inner sleeve including an upper portion disposed circumferentially around an inner surface of the root area of the blade within an inner cavity and a lower portion disposed circumferentially around an inner portion of the annular ridge of the root area of the blade; and
a fastener configured to attach and draw the inner sleeve and outer sleeve together to clamp the annular ridge of the root area of the blade therebetween.

17. The blade assembly of claim 16, wherein the lower portion of the inner sleeve is configured to extend through the root opening and the through-bore of the outer sleeve; and
wherein the fastener includes a nut configured to thread onto the lower portion of the inner sleeve extending through the root opening and the through-bore of the outer sleeve.

18. The blade assembly of claim 16, wherein the lower portion of the inner sleeve includes a threaded bore; and
wherein the fastener includes a bolt configured to pass into the through-bore of outer sleeve and thread into the threaded bore of the inner sleeve.

19. The blade assembly of claim 16, wherein the fastener is a threaded fastener.

20. The blade assembly of claim 16, wherein the inner sleeve is bonded to the inner surface of the root area by a resin transfer process.

21. The blade assembly of claim 20, wherein the outer sleeve is bonded by an adhesive to the outer surface of the root area of the blade.

22. The blade assembly of claim 16, wherein the annular ridge of the root area of the blade forms a toroidal loop extending inwards from the outer surface of the root area.

23. The blade assembly of claim 22, further comprising a ring disposed within the opening of the loop of the root area.

24. A method of attaching a blade to a blade retention assembly; the method comprising:
attaching an inner sleeve of the blade retention assembly within a cavity of a root area of the blade by a resin transfer molding process; and
attaching an outer sleeve of the blade retention assembly to an outer surface of root area of the blade after completion of the resin transfer molding process.

25. The method of claim 24, wherein the attaching the outer sleeve to the outer surface of the root area occurs when the inner sleeve, blade and the outer sleeve are at a temperature to minimize thermal stress therebetween.

26. The method of claim 24, wherein the temperature to minimize thermal stress is approximately room temperature.

27. The method of claim 24, wherein the resin molding process comprises:
wrapping dry sheet material about at least a portion of an outer surface of the inner sleeve;
placing the wrapped inner sleeve within a mold; and
injecting resin within the mold.

28. The method of claim 24, wherein the resin molding process comprises:
wrapping dry sheet material about an inner ring of a toroidal portion of the root area and between the inner ring and at least a portion of an outer surface of the inner sleeve;
placing the wrapped inner ring and inner sleeve within a mold; and
injecting resin within the mold.

29. The method of claim 28, wherein the toroidal portion of the root area of the blade extends radially inward and an outer surface of the root area is generally uniform and cylindrical in shape.

30. The method of claim 24 further comprising:
threading a nut onto a portion of the inner sleeve extending through the root portion and the outer sleeve to clamp a portion of the blade between the inner sleeve and the outer sleeve.
